(19) United States
(12) Patent Application Publication
(10) Pub. No.: US 2009/0295546 A1
(43) Pub. Date: Dec. 3, 2009

(54) METHOD AND APPARATUS FOR PERFORMING WIRELESS SENSOR NETWORK COMMUNICATING SELECTIVELY USING INFRARED AND RADIO FREQUENCY COMMUNICATION

(76) Inventors: Young-Guk Ha, Daejeon (KR); Joo-Chan Sohn, Daejeon (KR); Won-Pil Yu, Ulsan (KR); Young-Jo Cho, Kyungki-do (KR)

Correspondence Address: STAAS & HALSEY LLP, SUITE 700, 1201 NEW YORK AVENUE, N.W., WASHINGTON, DC, 20005, US

(21) Appl. No.: 12/306,440

(22) PCT Filed: Aug. 10, 2006
(86) PCT No.: PCT/KR06/03134

§ 371 Date: Jul. 6, 2009

(30) Foreign Application Priority Data
Jun. 23, 2006 (KR) 10-2006-0057004

(51) Int. Cl. H04Q 5/22

(52) U.S. Cl. 340/10.33

(57) ABSTRACT

A wireless sensor network communication apparatus and method selectively using infrared and radio frequency communication. The wireless sensor network communication apparatus includes a first communicating unit, a second communication unit, and a wireless node processor. The first communicating unit wakens a neighboring node in a sleep mode and transmits/receives the woken node and sensor data. The second communicating unit transmits/receives the woken neighboring node and the sensor data. The wireless node processor is wakened from the sleep mode, wakens the neighboring node in the sleep mode, and transmits the sensor data with a minimum low power through one of the first and second communicating unit. Accordingly, the apparatus can perform the wireless sensor network communication with lower power compared to the case that communication is performed only by the radio frequency communication function.

### TECHNICAL FIELD

The present invention relates to a wireless sensor network, and more particularly, to a wireless sensor network communication apparatus and method for selectively performing infrared and radio frequency communication depending on communication environment for low power communication, and a wireless sensor network system using the same.

### BACKGROUND ART

Recently, a ubiquitous computing technology and a wireless sensor network or ubiquitous sensor network (USN) technology come into the spotlight as a next generation computing technology according to the development and popularization of a computer networking technology. The ubiquitous computing technology was developed for providing various computing services to users at anytime and anywhere. Such a ubiquitous computing technology was basically developed from a wireless sensor network. That is, invisible computers and sensors are mounted around users and connected through a wireless network. Theses sensors and computers sense diverse data. The ubiquitous computing technology provides various services to users by recognizing context and peripheral environment based on the sensed data from the sensors and computers. It is clearly expected that the wireless sensor network technology will be a core technology in a future ubiquitous computing era.

A low power radio frequency technology is used for an Ad hoc communication between sensor nodes in a general wireless sensor network system. As an example, Bluetooth and Zigbee are representative technologies which are recently noticeable as a low power wireless standard technology.

### DISCLOSURE

### Technical Problem

Although the recent radio frequency communication technologies support the low power communication, it is very difficult that a small wireless sensor using a small quantity of battery acquires significant practical using time, e.g., longer than one year. It is a problem that should be necessarily solved to commercialize and realize the ubiquitous computing.

### Technical Solution

An object of the present invention is to provide a wireless sensor network communication apparatus and method which can perform wireless communication with small power consumption.

Another object of the present invention is to provide a wireless sensor network communication apparatus and method for selectively performing one that consumes less power consumption among a plurality of wireless communicating methods.

### ADVANTAGEOUS EFFECTS

The present invention can realize a wireless sensor network communication with lower power in comparison with the case that communication is performed only by the radio frequency communication function by synthetically including the radio frequency communicating unit and the radio frequency transmitting/receiving unit for radio frequency communication, and the infrared communicating unit and the infrared transmitting/receiving unit for infrared communication, and selectively performing the infrared and radio frequency communication for low power consumption.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing a wireless sensor communication apparatus for selectively performing an infrared communication method and a radio frequency communicating method for low power communication according to an embodiment of the present invention;

FIGS. 2 to 4 are views of an infrared communication sensor network using a wireless sensor communication apparatus 100 according to an embodiment of the present invention;

FIGS. 5 to 8 are views of a wireless sensor network formed for integrally providing infrared communication and radio frequency communication using a wireless sensor communication apparatus 100 according to an embodiment of the present invention; and

FIG. 9 is a flowchart describing a wireless sensor communicating method for selectively performing infrared and radio frequency communicating methods for low power consuming communication according to an embodiment of the present invention.

### BEST MODE

Accordingly, the present invention is directed to a wireless sensor network communication apparatus method for selectively using infrared and radio frequency communication and a wireless sensor network system using the same that substantially obviates one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a wireless sensor network communication apparatus, including: a first communicating unit for wakening a neighboring node in a sleep mode through an infrared signal and transmitting/receiving the woken node and sensor data; a second communicating unit for transmitting/receiving the woken neighboring node and the sensor data through a radio frequency signal; and a wireless node processing unit for wakening from the sleep mode when a wake-up signal of the infrared signal is received through the first communicating unit, wakening the neighboring node in the sleep mode through the first communicating unit to transmit the received sensor data to the object node when the sensor data are received through one of the first and second communicating unit, and transmitting the sensor data with a minimum low power through one of the first and second communicating unit.

The first communicating unit includes: at least one infrared transmitter/receiver for transmitting/receiving the infrared signal by emitting and sensing the infrared signal; and an infrared communicator for converting a wake up signal for wakening the neighboring node into the infrared signal, transmitting the infrared signal to the neighboring node through the infrared transmitter/receiver, converting the sensor data into the infrared signal, receiving the wake-up signal through the infrared transmitter/receiver and transmitting the wake-up signal to the woken neighboring node.

The second communicating unit includes: a radio frequency transmitter/receiver for transmitting/receiving the radio frequency signal; and a radio frequency communicator for converting the sensor data into the radio frequency signal and transmitting the radio frequency signal to the woken neighboring node.

The wireless sensor network communication apparatus, further includes: a sensor for sensing an electric signal transmitted to the air as the sensor data; and a sensor connecting unit for providing the sensor data sensed by the sensor to the wireless node processing unit. The wireless node processing unit selectively controls an operation of the first and second communicating unit for minimum power consumption to transmit the sensor data to the object node.

The wireless sensor network communication apparatus is divided into a sensor node for sensing the sensor data through the sensor, an object node which is a final object for receiving the sensor data, and a relay node which is positioned between the sensor node and the object node and relaying transmission of the sensor data to transmit the sensor data from the sensor node to the object node according to a process role of the nodes with respect to the sensor data in the wireless sensor network.

The wireless node processing unit uses the infrared signal to waken the neighboring node and uses the radio frequency signal to transmit the sensor data.

The second communicating unit performs communication through one communicating method of Bluetooth and Zigbee.

According to an aspect of the present invention, there is provided a wireless sensor network communicating method, including: a) maintaining a sleep mode after entering into a wireless node status; b) determining whether data to be transmitted are generated in the sleep mode; c) when the data to be transmitted are generated, converting the sleep mode into a wake-up mode; d) converting the wake-up signal for wakening a neighboring node into a first communicating method signal, transmitting the first communicating method signal to the neighboring node and wakening the neighboring node; and e) converting the data into a second communicating method signal, receiving the wake-up signal converted into the first communicating method signal and transmitting the first communicating method signal to the woken neighboring node.

The first and second communicating method signals are infrared communicating method signals. The first communicating method signal is an infrared signal and the second communicating method signal is a radio frequency communicating method signal.

The wireless sensor network communicating method, further includes; f) when the data are transmitted to the woken neighboring node, determining whether there are rest data to be transmitted; and g) when it is determined that there are no data to be transmitted, transmitting a transmission end signal of the data to the neighboring node.

The wireless sensor network communicating method, further includes; h) when the transmission end signal of the data is transmitted to the neighboring node, converting the wake-up mode into the sleep mode.

The wireless sensor network communicating method, further includes; i) when the transmission end signal of the data is received, determining in the neighboring node receiving the data whether a current node is an object node or a relay node; and j) when the current node is the object node, processing the received data.

The wireless sensor network communicating method, further includes; k) when the current node is the relay node, performing the wakening step of the step d) and the transmitting step of the step e), and transmitting the data to the object node.

It is to be understood that both the foregoing general description and the following detailed description of the present invention are exemplary and explanatory and are intended to provide further explanation of the invention as claimed.

### MODE FOR INVENTION

Reference will now be made in detail to the preferred embodiments of the present invention, examples of which are illustrated in the accompanying drawings.

To overcome the problem of the power consumption in the wireless sensor network system, the present invention suggests a method which can perform wireless communication with a low power by establishing a wireless sensor communication apparatus capable of using both of infrared communication and radio frequency communication, and a wireless sensor network system using the same, and selectively performing the infrared and radio frequency communication in wireless communication between wireless sensor nodes.

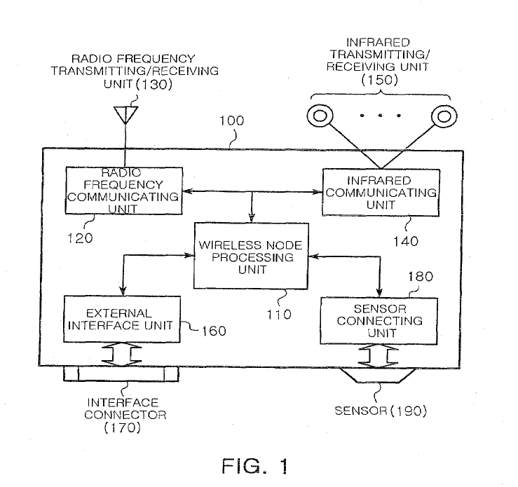

FIG. 1 is a block diagram showing a wireless sensor communication apparatus for selectively performing an infrared communication method and a radio frequency communicating method for low power communication according to an embodiment of the present invention.

Referring to FIG. 1, a wireless sensor communication apparatus 100 for a wireless sensor network system of the present invention includes a wireless node processing unit 110, a radio frequency communicating unit 120, a radio frequency transmitting/receiving unit 130, an infrared communicating unit 140, an infrared transmitting/receiving unit 150, an external interface unit 160, an interface connector 170, a sensor connecting unit 180, and a sensor 190.

The wireless node processing unit 110 is connected to each constitutional element of the wireless sensor communication apparatus 100 and controls general operations of the constitutional elements. The wireless node processing unit 110 controls to selectively perform the radio frequency and infrared communication in accordance with an embodiment of the present invention.

The radio frequency communicating unit 120 performs a conventional radio frequency communication, e.g., Bluetooth and Zigbee, through the radio frequency transmitting/receiving unit 130. When the wireless sensor communication apparatus 100 performs only the infrared communication, the radio frequency communicating unit 120 may be excluded from the wireless sensor communication apparatus 100.

The infrared communicating unit 140 processes an infrared signal to transmit and/or to receive the infrared signal between sensor nodes through the infrared transmitting/receiving unit 150. The infrared transmitting/receiving unit 150 transmits or senses the infrared signal.

The external interface unit 160 provides an interface to be connected to an external application system through the interface connector 170.

The sensor connecting unit 180 processes an electric signal sensed and inputted from the diverse sensors 190 and provides the electric signal to the wireless node processing unit 110.

That is, the wireless sensor communication apparatus 100 of the present invention synthetically includes the radio frequency communicating unit 120 and the radio frequency transmitting/receiving unit 130 for the radio frequency communication, and the infrared communicating unit 140 and the infrared transmitting/receiving unit 150 for the infrared communication.

Accordingly, the wireless node processing unit 110 selectively controls the radio frequency and infrared communication to consume a minimum power. That is, the wireless node processing unit 110 determines whether an environment is proper for the infrared communication consuming the minimum power. When the environment is proper for the infrared communication, the wireless node processing unit 110 controls the infrared communicating unit 140 to perform the infrared communication. When the environment is not proper for the infrared communication, the wireless node processing unit 110 controls the radio frequency communicating unit 120 to perform the radio frequency communication.

As described above, the wireless sensor communication apparatus 100, i.e., a node included in the wireless sensor network system, according to the present embodiment synthetically includes the radio frequency communicating unit 120 and the radio frequency transmitting/receiving unit 130 for radio frequency communication and the infrared communicating unit 140 and the infrared transmitting/receiving unit 150 for infrared communication. And, the wireless sensor communication apparatus 100 selectively performs the infrared and radio frequency communication for low power consuming communication. Therefore, the wireless sensor network communication can be archived with lower power consumption compared to a case that communication is performed only by the radio frequency communication function.

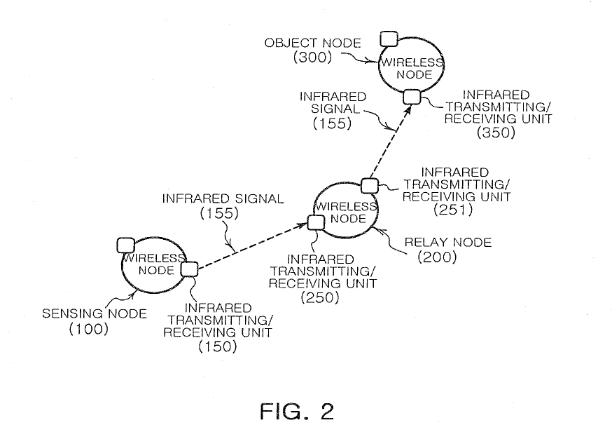

FIGS. 2 to 4 are views of an infrared communication sensor network using a wireless sensor communication apparatus 100 according to an embodiment of the present invention.

FIG. 2 shows a first example of an infrared communication sensor network using the wireless sensor communication apparatus 100 according to an embodiment of the present invention.

Each of the wireless sensor communication apparatuses 100, 200 and 300 included in an Ad hoc sensor network has at least one of the infrared transmitting/receiving units 150, 250, 251 and 350. Each of the wireless sensor communication apparatuses 100, 200 and 300 is described as a wireless node in drawings hereinafter. Also, the wireless nodes are divided into a sensing node, a relay node and an object node according to a kind of the operations. The sensing node senses specific information through the sensor 190. The relay node transmits an infrared signal corresponding to the sensed information transmitted from the sensing node to the object node. The object node receives the infrared signal transmitted from the sensing node through the relay node. Therefore, each of the wireless sensor communication apparatuses displayed in the drawings according to the kind of the operations will be described as the sensing node, the relay node or the object node.

The wireless sensor communication apparatuses 100, 200 and 300, i.e., wireless nodes, transmit/receive infrared signals 155 and 255 through at least one of the infrared transmitting/receiving units 150, 250, 251 and 350 prepared for each wireless node.

To be specific, the sensing node 100 senses specific information through the mounted sensor 190. The sensing node 100 transmits the infrared signal 155 corresponding to the data sensed through the infrared transmitting/receiving unit 150 to the relay node 200 to transmit the sensed data to the object node 300.

The relay node 200 receives the infrared signal 155 transmitted from the sensing node 100 through the equipped infrared transmitting/receiving unit 250 and transmits the infrared signal 155 transmitted through the equipped infrared transmitting/receiving unit 251 to the object node 300. In this process, the relay node 200 may be more than one.

In this embodiment, the infrared signal 155 is used for two objects. The infrared signal 155 is used for a first object for waking up the wireless node in a sleep mode to save power and a second object for transmitting the data to the woken wireless node. When all wireless nodes are synchronized to a specific duty cycle or in the wake-up mode, the infrared signal 155 can be used only for transmitting data.

The object node 300 receives the infrared signal 155 transmitted from the relay node 200 through the equipped infrared transmitting/receiving unit 350.

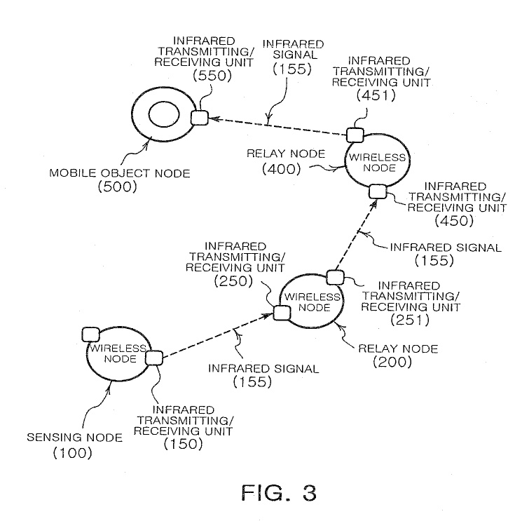

FIG. 3 shows a second example of the infrared communication sensor network using the wireless sensor communication apparatus 100 according to an embodiment of the present invention.

The infrared communication sensor network shown in FIG. 3 shows a case that a mobile node, e.g., a mobile robot, is included on the sensor network.

The infrared communication sensor network has the wireless node sensing the corresponding information through the sensor 190 as the sensing node 100, the mobile node as the object node 500, the wireless nodes between the sensing node 100 and the object node 500 as the relay nodes 200 and 400.

The sensing node 100 senses specific information through the mounted sensor 190. The sensing node 100 transmits the infrared signal 155 corresponding to the data sensed through the infrared transmitting/receiving unit 150 to the relay node 200 in order to transmit the sensed data to the mobile object node 500.

The relay node 200 receives the infrared signal 155 transmitted from the sensing node 100 through the equipped infrared transmitting/receiving unit 250, and transmits the infrared signal 155 transmitted through the equipped infrared transmitting/receiving unit 251 to the relay node 400. The relay node 400 receives the infrared signal 155 transmitted from the relay node 200 through an equipped infrared transmitting/receiving unit 450 and transmits the infrared signal 155 transmitted through the equipped infrared transmitting/receiving unit 451 to the mobile object node 500.

In this process, the wireless nodes 100, 200 and 400 adopt a dynamic routing protocol such as an Ad hoc network routing protocol including Dynamic Source Routing (DSR) and Ad hoc On Demand Distance Vector (AODV) in order to transmit data to the mobile object node 500.

Meanwhile, the mobile object node 500 receives the infrared signal 155 transmitted from the relay node 400 through the equipped infrared transmitting/receiving unit 550.

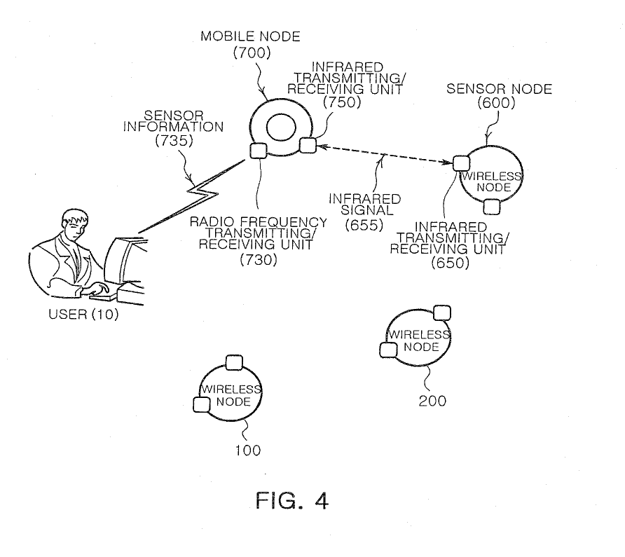

FIG. 4 shows a third example of an infrared communication sensor network using the wireless sensor communication apparatus 100 according to an embodiment of the present invention.

The infrared communication sensor network shown in FIG. 4 has a formation that the mobile node 700 directly requests data transmission to a neighboring sensor node during going round a sensor network region, receives the data and transmits the received data to the user.

The mobile node 700 accesses to the neighboring sensor node 600 based on an infrared signal 655 through the infrared transmitting/receiving unit 750. The mobile node 700 requests the data transmission based on the infrared signal 655. The sensor node 600 transmits the data to the mobile node 700 as the infrared signal 655 through an infrared transmitting/receiving unit 650 upon request of the mobile node 700.

The mobile node 700 transmits sensor information 735 collected by the infrared transmitting/receiving unit 750 to the user 10 on communication network, e.g., Radio Access Network (RAN), through an equipped radio frequency transmitting/receiving unit 730. The network can be formed of an application service that the mobile robot 700 collects and checks information on a battery status of wireless nodes 100, 200, and 600 during going round the sensor network region, and notifies result information to the user 10.

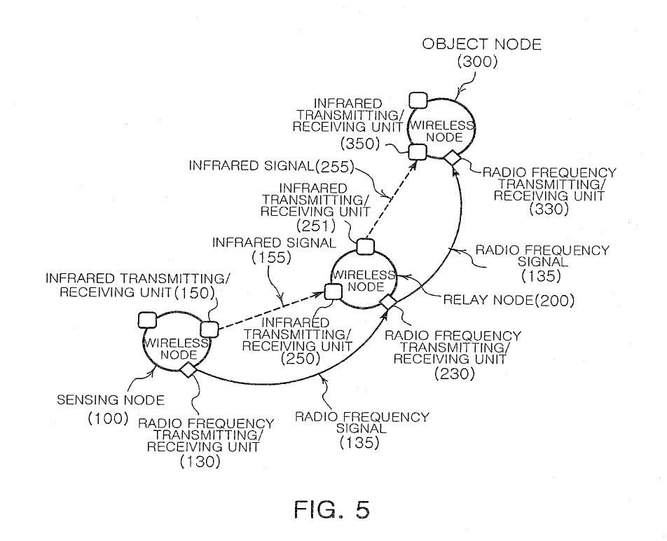

FIGS. 5 to 8 are views of a wireless sensor network combined with infrared communication and radio frequency communication using a wireless sensor communication apparatus 100 according to an embodiment of the present invention.

The wireless sensor network synthetically includes the infrared and radio frequency communication. Accordingly, the wireless sensor network can provide connection and compatibility between the infrared communication method and the conventional radio frequency communicating method. Also, the radio frequency communicating method can be efficiently applied in an environment such as the infrared communication where a large quantity of high-speed data cannot be transmitted.

FIG. 5 show a first example of the sensor network combined with the infrared communication and the radio frequency communication using the wireless sensor communication apparatus 100 according to the embodiment of the present invention.

Each of the wireless nodes 100, 200 and 300 of the combined sensor network includes at least one of the radio frequency transmitting/receiving units 130, 230 and 330, and at least one of the infrared transmitting/receiving units 150, 250, 251 and 350.

The infrared signal 155 is used to waken a reception node from the sleep mode by the transmission node and a radio frequency signal 135 is used to transmit the sensed data to the waken reception node by the transmission node. In this case, the infrared communication unit of each node can be simply formed. For example, the infrared communication unit can be easily realized by mounting only an interrupt signal process function for waking up the wireless node in the infrared communication unit without mounting a protocol or a data process function required for data transmission.

A sensing process of the information and transmitting process of the sensed data will be described in detail hereinafter.

The sensing node 200 woken from a sleep mode by the sensed data transmits the infrared signal 155 to the relay node 200 through the infrared transmitting/receiving unit 150 and wakens the relay node 200 from the sleep mode. Subsequently, the relay node 200 wakens from the sleep mode by receiving infrared signal 155 transmitted from the sensing node 100 through the infrared transmitting/receiving unit 251.

The sensing node 100 transmits the radio frequency signal 135 corresponding to the sensed data to the relay node 200 through the radio frequency transmitting/receiving unit 130. When the radio frequency signal 135 is transmitted, the status of the sensing node 100 is converted from the wake-up mode into the sleep mode.

The relay node 200 receives the radio frequency signal 135 transmitted from the sensing node 100 through the radio frequency transmitting/receiving unit 230. To transmit the radio frequency signal 135 corresponding to the received sensing data to the object node 300, the relay node 200 transmits the infrared signal 255 to the object node 300 through the infrared transmitting/receiving unit 251 and wakens the object node 300 from the sleep mode. Subsequently, the object node 300 receives the infrared signal 255 transmitted from the relay node 200 through the infrared transmitting/receiving unit 350 and wakens from the sleep mode.

The relay node 200 transmits the radio frequency signal 135 received through the radio frequency transmitting/receiving unit 230 to the object node 300 woken from the sleep mode. Subsequently, when the radio frequency signal 135 is transmitted, the status of the relay node 200 is converted from the wake-up mode into the sleep mode again.

The object node 300 in the wake-up mode receives the radio frequency signal 135 transmitted from the relay node 200 through the radio frequency transmitting/receiving unit 330.

The data sensed in the wireless sensor network can be transmitted with low power by performing the infrared communication to transmit a small quantity of data with low power for waking up the wireless node in the sleep mode and performing the radio frequency communication to fast transmit a large quantity of data.

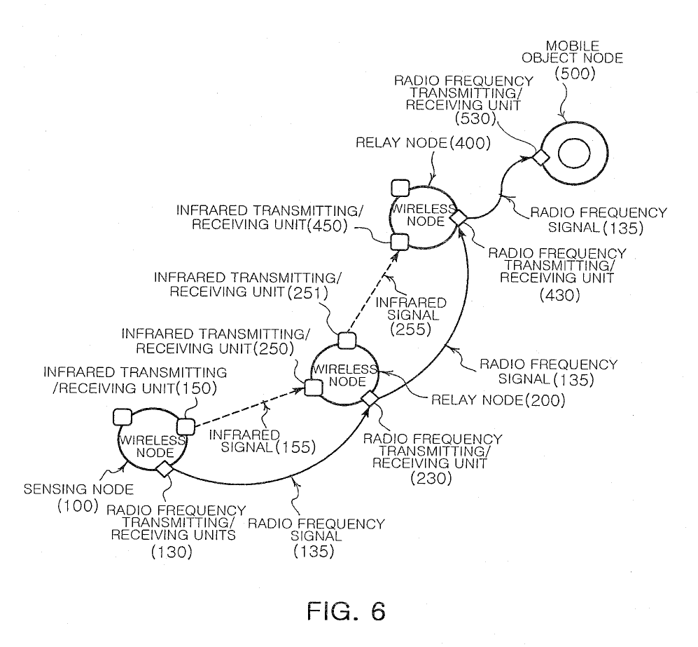

FIG. 6 shows a second example of the sensor network combined with the infrared and radio frequency communication using the wireless sensor communication apparatus 100 according to an embodiment of the present invention.

The combined wireless sensor network shown in FIG. 6 shows a formation that a mobile object node 406 is added to the formation of FIG. 5. A method for transmitting the sensing data from the sensing node 100 to the final relay node 400 through the relay node 200 is the same as the method of FIG. 5.

As shown in FIG. 3, the final relay node 400 adopts a dynamic routing protocol such as the Ad hoc network routing to transmit data to the mobile object node 500. Since the mobile object node 500 can load and frequently charge a large quantity of battery, it is assumed that it is unnecessary to convert the status of the mobile object node 500 into the sleep mode for the low power consumption.

Therefore, the final relay node 400 transmits the radio frequency signal 135 transmitted from the sensing node 100 through the relay node 200 to the mobile object node 500 based on the dynamic routing protocol. Subsequently, the mobile object node 500 receives the radio frequency signal 135 transmitted from the relay node 400 through the radio frequency transmitting/receiving unit 530.

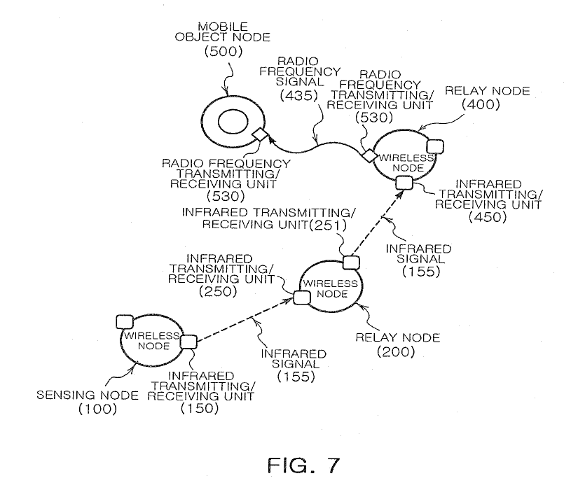

FIG. 7 shows a third example of the sensor network combined with the infrared communication and the radio frequency communication using the wireless sensor communication apparatus 100 in accordance with the embodiment of the present invention.

In the combined wireless sensor network shown in FIG. 7, a formation that the sensor data are transmitted from the sensing node 100 to the mobile object node 500 is the same as the formation of FIG. 3. The method for transmitting the sensing data from the final relay node 400 to the mobile object node 500 has a difference that the radio frequency signal 435 corresponding to the sensing data is used through a radio frequency transmitting/receiving unit 430.

The formation is proper to an environment having many obstacles where a line of sight between sensor nodes and the mobile object node cannot be secured while the mobile object node 500 goes round.

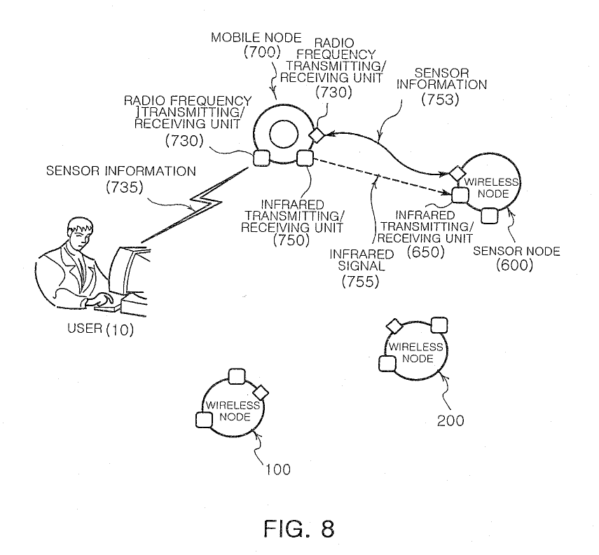

FIG. 8 shows a fourth example of the sensor network combining the infrared communication and the radio frequency communication using the wireless sensor communication apparatus 100 in accordance with the embodiment of the present invention.

The wireless sensor network shown in FIG. 8 has a formation that the mobile node 700 wakens the neighboring sensor node 600 during going round the sensor network region, directly requests data transmission, receives the data and transmits the data to the user.

The mobile node 700 wakens the sensor node 600 by transmitting an infrared signal 755 to the neighboring sensor node 600 through the infrared transmitting/receiving unit 750 during going round the sensor network region. The sensor node 600 receives the infrared signal 755 transmitted from the mobile node 700 through the equipped infrared transmitting/receiving unit 650 and wakens from the sleep mode.

Subsequently, the mobile node 700 transmits a radio frequency signal 753 through the radio frequency transmitting/receiving unit 730 and requests transmission of the data to the sensor node 600. The sensor node 600 transmits the corresponding data to the mobile node 700 as the radio frequency signal 753 upon request of the mobile node 700.

Accordingly, the mobile node 700 receives the data transmitted from the sensor node 600 through the radio frequency transmitting/receiving unit 730. The mobile node 700 transmits the data to the user 10 through the equipped radio frequency transmitting/receiving unit 730 on communication network such as the wireless RAN.

The network can be formed of an application service that the mobile robot 700 collects and checks information on a battery status of wireless nodes 100, 200, and 600 during going round the sensor network region, and notifies result information to the user 10.

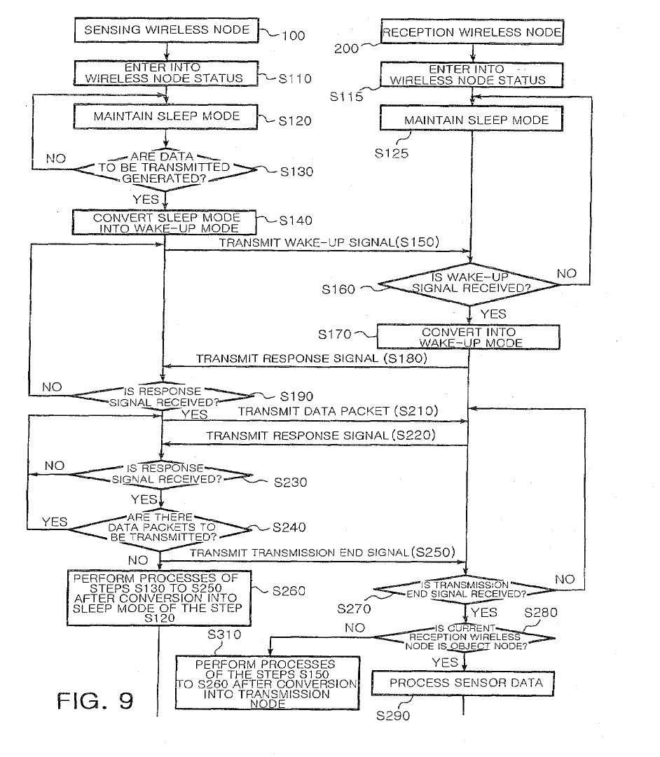

FIG. 9 is a flowchart describing a wireless sensor communicating method for selectively performing infrared and radio frequency communicating methods for low power consuming communication according to an embodiment of the present invention.

In the embodiment of the present invention, a Wake-and-Tell data transmitting method is used to transmit data with low power between wireless sensor nodes. In the Wake-and-Tell data transmitting method, the transmission wireless sensor node 100 transmits an infrared signal, wakens the reception wireless sensor node 300 in the sleep mode by consuming the minimum power, and receives sensor data from the woken reception wireless sensor node 300 through the infrared signal or the radio frequency signal.

The transmission wireless sensor nodes, i.e., the sensing wireless node 100, and the reception wireless sensor node, i.e., the reception wireless node 200 enters into the wireless node status at steps S110 and S115 and maintains the sleep mode at steps S120 and S125.

The sensing wireless node 100 maintaining the sleep mode determines whether data to be transmitted are generated by sensing information through the sensor 190 at step S130. When it is determined that the data to be transmitted are generated, the status of the sensing wireless node 100 is converted from the sleep mode into a wake-up mode at step S140. The sensing wireless node 100 transmits a wake-up signal to the reception wireless node 200 at step S150 to waken the reception wireless node 200, which is a next relay node, before transmitting the data. The sensing wireless node 100 determines the next relay node through a routing protocol used to the wireless sensor network. In this embodiment, the sensing wireless node 100 transmits the wake-up signal as the infrared signal for low power transmission.

The reception wireless node 200 determines at step S160 whether the infrared wake-up signal transmitted from the sensing wireless node 100 is received. When it is determined that the wake-up signal is not received, the reception wireless node 200 maintains the sleep mode of the step S125.

When it is determined that the wake-up signal is received, the status of the reception wireless node 200 is converted from the sleep mode into the wake-up mode at step S170. The reception wireless node 200 transmits a reception response signal with respect to the wake-up signal to the sensing wireless node 100 as an infrared signal at step S180.

The sensing wireless node 100 transmitting the wake-up signal at the step S140 determines at step S190 whether the reception response signal of the wake-up signal transmitted from the reception wireless node 200 is received. When it is determined that the reception response signal is not received, the sensing wireless node 100 retransmits the wake-up signal to the reception wireless node.

When it is determined that the reception response signal is received, the sensing wireless node 100 transmits a data packet to be transmitted as the infrared or radio frequency signal to the reception wireless node 200 at step S210. When the high-speed transmission of the data is not necessary, the sensing wireless node 100 transmits the data as the infrared signal. When the high-speed transmission of the data is necessary, the sensing wireless node 100 transmits the data as the radio frequency signal.

When the reception wireless node 200 receives the data packet of the infrared or radio frequency from the sensing wireless node 100, the reception wireless node 200 transmits the reception response signal to the sensing wireless node 100 at step S220 according to the same method for transmitting the data packet.

The sensing wireless node 100 determines in the data packet whether the reception response signal with respect to the data packet transmitted from the reception wireless node 200 is received at step S230. When it is determined that the reception response signal with respect to the data packet is not received, the sensing wireless node 100 retransmits the transmitted data packet as the infrared or radio frequency signal.

When it is determined that the reception response signal with respect to the data packet is received, the sensing wireless node 100 determines at step S240 whether there are rest data packets to be transmitted. When it is determined that there are the data packets to be transmitted, the sensing wireless node 100 transmits the data packet as the infrared or radio frequency signal to the reception wireless node 200.

When there is no data packet to be transmitted, the sensing wireless node 100 transmits a transmission end signal of the data packet as the infrared or radio frequency signal to the reception wireless node 200 at step S250. Subsequently, the sensing wireless node 100 transmits the transmission end signal and the status of the sensing wireless node 100 is converted into the sleep mode. The processes of the steps S130 to S250 are performed at step S260.

The reception wireless node 200 determines at step S270 whether the transmission end signal transmitted from the sensing wireless node 100 is received. When it is determined that the transmission end signal is not received, the reception wireless node 200 waits to receive the data packet to be transmitted from the sensing wireless node 100.

When it is determined that the transmission end signal transmitted from the sensing wireless node 100 is received, the reception wireless node 200 determines at step S280 whether the current reception wireless node 200 is an object node or a relay node. When it is determined that the current node is the object node, the reception wireless node 200 processes the sensor data packet and the status of the reception wireless node 200 is converted into the sleep mode again at step S290.

When it is determined that the current node is the relay node, the reception wireless node 200 becomes a new transmitting node, i.e., the relay node. Subsequently, processes of the steps S150 to S260 for restarting to transmit the wake-up signal and relaying the transmission of the data packet are performed at step S310. A next relay node is selected by a routing protocol used in the wireless sensor network.

The present invention can realize a wireless sensor network communication with lower power in comparison with the case that communication is performed only by the radio frequency communication function by synthetically including the radio frequency communicating unit and the radio frequency transmitting/receiving unit for radio frequency communication, and the infrared communicating unit and the infrared transmitting/receiving unit for infrared communication, and selectively performing the infrared and radio frequency communication for low power consumption.

It will be apparent to those skilled in the art that various modifications and variations can be made in the present invention. Thus, it is intended that the present invention covers the modifications and variations of this invention provided they come within the scope of the appended claims and their equivalents.

1. A wireless sensor network communication apparatus, comprising:
a first communicating means for wakening a neighboring node in a sleep mode through an infrared signal and transmitting/receiving the woken node and sensor data;
a second communicating means for transmitting/receiving the woken neighboring node and the sensor data through a radio frequency signal; and a wireless node processing means for being wakened from the sleep mode when a wake-up signal of the infrared signal is received through the first communicating means, wakening the neighboring node in the sleep mode through the first communicating means to transmit the received sensor data to the object node when the sensor data are received through one of the first and second communicating means, and transmitting the sensor data with a minimum low power through one of the first and second communicating means.

2. The apparatus of claim 1, wherein the first communicating means includes:
at least one infrared transmitting/receiving unit for transmitting/receiving the infrared signal by emitting and sensing the infrared signal; and
an infrared communicating unit for converting a wake up signal for wakening the neighboring node into the infrared signal, transmitting the infrared signal to the neighboring node through the infrared transmitting/receiving unit, converting the sensor data into the infrared signal, receiving the wake-up signal through the infrared transmitting/receiving unit and transmitting the wake-up signal to the woken neighboring node.

3. The apparatus of the claim 1, wherein the second communicating means includes:
a radio frequency transmitting/receiving unit for transmitting/receiving the radio frequency signal; and
a radio frequency communicating unit for converting the sensor data into the radio frequency signal and transmitting the radio frequency signal to the woken neighboring node.

4. The apparatus of claim 3, further comprising:
a sensor for sensing an electric signal transmitted to the air as the sensor data; and
a sensor connecting means for providing the sensor data sensed by the sensor to the wireless node processing means,
wherein the wireless node processing means selectively controls an operation of the first and second communicating means for minimum power consumption to transmit the sensor data to the object node.

5. The apparatus of the claim 4, wherein the wireless sensor network communication apparatus is divided into a sensor node for sensing the sensor data through the sensor, an object node which is a final object for receiving the sensor data, and a relay node which is positioned between the sensor node and the object node and relaying transmission of the sensor data to transmit the sensor data from the sensor node to the object node according to a process role of the nodes with respect to the sensor data in the wireless sensor network.

6. The apparatus of the claim 5, wherein the wireless node processing means uses the infrared signal to waken the neighboring node and uses the radio frequency signal to transmit the sensor data.

7. The apparatus of the claim 3, wherein the second communicating means performs communication through one communicating method of Bluetooth and Zigbee.

8. A wireless sensor network communicating method, comprising the steps of:
a) maintaining a sleep mode after entering into a wireless node status;
b) determining whether data to be transmitted are generated in the sleep mode;
c) transiting the sleep mode into a wake-up mode if the data to be transmitted are generated;
d) converting the wake-up signal for wakening a neighboring node into a first communicating method signal, transmitting the first communicating method signal to the neighboring node and wakening the neighboring node; and
e) converting the data into a second communicating method signal, receiving the wake-up signal converted into the first communicating method signal and transmitting the first communicating method signal to the woken neighboring node.

9. The method of the claim 8, wherein the first and second communicating method signals are infrared communicating method signals.

10. The method of the claim 8, wherein the first communicating method signal is an infrared signal and the second communicating method signal is a radio frequency communicating method signal.

11. The method of the claim 8, further comprising:
f) determining whether data to be transmitted is present after transmitting the data to the woken neighboring node; and
g) transmitting a transmission end signal of the data to the neighboring node if no data to be transmitted is present.

12. The method of the claim 11, further comprising:
h) converting the wake-up mode into the sleep mode after transmitting the transmission end signal of the data to the neighboring node.

13. The method of the claim 12, further comprising:
i) at the neighboring node receiving the data, determining whether a current node is an object node or a relay node when the transmission end signal of the data is received; and
j) processing the received data if the current node is the object node.

14. The method of the claim 13, further comprising:
k) transmitting the data to the object node by performing the steps d) and e) if the current node is the relay node.
